(19) United States
(12) Patent Application Publication
(10) Pub. No.: US 2019/0187854 A1
(43) Pub. Date: Jun. 20, 2019

(54) TOUCH FORCE DETECTION FOR A TOUCH SYSTEM

(71) Applicant: TEXAS INSTRUMENTS INCORPORATED, DALLAS, TX (US)

(72) Inventors: SRINATH HOSUR, CANYONLANDS DRIVE, TX (US); ASHISH KHANDELWAL, IRVING, TX (US); WILLIAM ROBERT KRENIK, GARLAND, TX (US)

(21) Appl. No.: 15/843,609

(22) Filed: Dec. 15, 2017

(51) Int. Cl. G06F 3/041; G06F 3/044

(52) U.S. Cl. CPC G06F 3/0414; G06F 3/0412; G06F 2203/04101; G06F 2203/04104; G06F 3/044

(57) ABSTRACT

A system includes a receiver that receives an output signal from a touch system to detect a user's touch. The output signal is received in response to an excitation signal that is applied to a row or column of the touch system. A touch force analyzer determines an indication of a touch force applied to the touch system based on detecting a change in phase of the output signal received from the row or column of the touch system in response to a touch applied to the touch system.

### TECHNICAL FIELD

This relates generally to integrated circuits, and more particularly to estimating a touch force applied in a touch system.

### BACKGROUND

A touch system includes interfaces such as touch screens that can include an input device and output device layered on top of an electronic visual display of an information processing system. For example, a user can provide input or control the information processing system through simple or multi-touch gestures by touching the screen with a special stylus and/or one or more fingers. Touch screens are common in devices, such as game consoles, personal computers, tablet computers, electronic voting machines, and smart phones. These interfaces can also be attached to computers or, as terminals, to networks.

To detect user gestures such as touching via the touch system interface, common technologies include resistive touch screens and capacitive touch screens can be employed. An example capacitive touch screen panel consists of an insulator such as glass, coated with a transparent conductor such as indium tin oxide. As the human body is also an electrical conductor, touching the surface of the screen results in a distortion of the screen's electrostatic field, measurable as a change in capacitance. Different technologies may be used to determine the location of the touch. In some touch systems, mutual or self capacitance can be measured by transmitting a signal on a row/column of the touch screen interface and receiving the signal on a respective column/row. When the touch occurs close to a row/column intersection, the received change in signal strength and/or signal phase changes. This change isolates the touch location. In addition to detecting touch location, the amount of touch force applied at a given location may be desired. Strain force resistors are often coupled to the mutual capacitance row/column intersections to determine the force applied. Such added resistors to determine touch force adds significant cost to the system.

### SUMMARY

In described examples, a system includes a receiver that receives an output signal from a touch system to detect a user's touch. The output signal is received in response to an excitation signal that is applied to a row or column of the touch system. A touch force analyzer determines an indication of a touch force applied to the touch system based on detecting a change in phase of the output signal received from the row or column of the touch system in response to a touch applied to the touch system.

In another example, a system includes a receiver that receives output signals from a touch system to detect a user's touch. The output signals are received in response to at least two out of phase excitation signals applied to at least two rows or columns of the touch system. A touch force analyzer determines an indication of a touch force applied to the touch system based on detecting a change in phase in at least one of the output signals received from the respective rows or columns of the touch system in response to a touch applied to the touch system.

In yet another example, a method includes transmitting an excitation signal to at least one row or column of a touch system. The method includes receiving an output signal from the touch system in response to the excitation signal; the output signal having an amplitude and phase that varies based on application of a touch to the touch system. The method includes comparing the phase of the output signal received from the row or column of the touch system responsive to the application of the touch to a predetermined phase of the output signal to determine a phase change for the output signal. The method includes determining an indication of touch force applied to the touch system based on the determined phase change.

### BRIEF DESCRIPTION OF THE DRAWINGS

FIG. 1 is a schematic block diagram of a system to determine touch location and touch force applied to a touch system.

FIG. 2 is an example circuit path including a row/column intersection demonstrating circuit transfer function characteristics to determine phase changes that can be used to detect touch force applied to a touch system.

FIG. 3 is a schematic block diagram of an example system to determine touch location and touch force applied to a touch system after multiple out of phase excitation signals are applied to the touch system.

FIG. 4 is a circuit diagram of a receiver and transmitter for an example touch system that uses multiphase signaling and processing.

FIG. 5 is a circuit diagram of an example touch system that can be excited and analyzed via multiphase signaling to determine touch location and touch force.

FIG. 6 is a circuit diagram of an example transmitter and receiver circuit that uses multiphase signaling and processing to determine touch location and touch force.

FIG. 7 is a flow diagram of an example method to determine touch force applied to a touch system.

### DETAILED DESCRIPTION

In example embodiments, received signals from a touch system are analyzed with respect to a received signal phase to determine a touch force of a user's touch applied to the rows or columns of the touch system. The touch system includes intersecting wires that make up the rows and columns of the touch system and include capacitive and resistance properties. As touch force is applied to the rows and columns, the resistance of the intersecting wires changes based on the amount of force applied (e.g., via finger or stylus). Such change in resistance can be detected as a change in phase of a received signal that is received in response to an excitation signal (or signals) applied by a transmitter to the touch system. When no touch force is applied to the touch system, a predetermined phase for the received signal can be observed and stored. When differing amounts of touch force are applied to the touch system, the phase changes relative to the predetermined phase. For example, if no touch force is applied, one phase value can be detected and stored. If maximum touch force is applied, a different phase in the received signal can be detected and stored. These two stored phase values can be utilized to detect touch forces between the minimum (no touch force applied) and maximum force applied by interpolating between the phase values of the received signal when an intermediate force is applied to the touch system. In another example, predetermined phase tables can be constructed based on measured forces applied to the touch system. Based on where a received signal phase is with respect to a given phase in the phase table, the amount of touch force can be determined based on a comparison of the received signal phase to the phase table.

In another example, touch location is (e.g., place where finger or stylus touches touch system) determined by analyzing the received amplitude of the received signal from the touch system that has been excited by one or more excitation signals from a transmitter. Based on the touch location (e.g., the row(s) or column(s) where the touch occurred), the respective phase of the receive signal can be determined (e.g., before or after determined location) for the given touch location (or locations). The received signal can be multiplied by a sine and cosine function and then low pass filtered by a digital processing circuit (e.g., digital signal processor). The multiplication and filtering isolates the real and the imaginary alternating current components of the received signal where the arctangent between the real and the imaginary components yield the phase (e.g., phase angle) of the received signal which can then be compared to predetermined phase angles/measurements to determine an indication of force applied. In some examples, touch force can be determined across multiple row and column intersections to determine how force is distributed across the touch system and per a given area of a touch panel of the touch system. Touch forces can be determined by interpolating between maximum and minimum touch force/phase values, comparing to a table of phase/force values, and/or averaging phase measurements over the course of time to determine phase values for the touch forces that are applied over time.

The touch system can be excited by a transmitter that transmits excitation signals that are out of phase with respect to each other (e.g., a sine wave generated as one excitation signal and a cosine wave generated as another excitation signal). At least one of the of excitation signals can be transmitted to at least one row or column of a touch system and at least one other of the excitation signals is concurrently transmitted to at least one other row or column of the touch system. An output signal having a combination of signals from each of the excitation signals can be received by a receiver in response to the excitation signals transmitted to the touch system. Receiver circuits extrapolate the row or column information from the output signal based on the phase of the excitation signals. For example, in a two phase excitation system, at least two receiver circuits include a summing junction to extrapolate signal phases from the output signal to determine which of at least two rows or columns was touched. After the touch location is determined, signal phase analysis as described herein can be utilized to determine the touch force applied to the touch system.

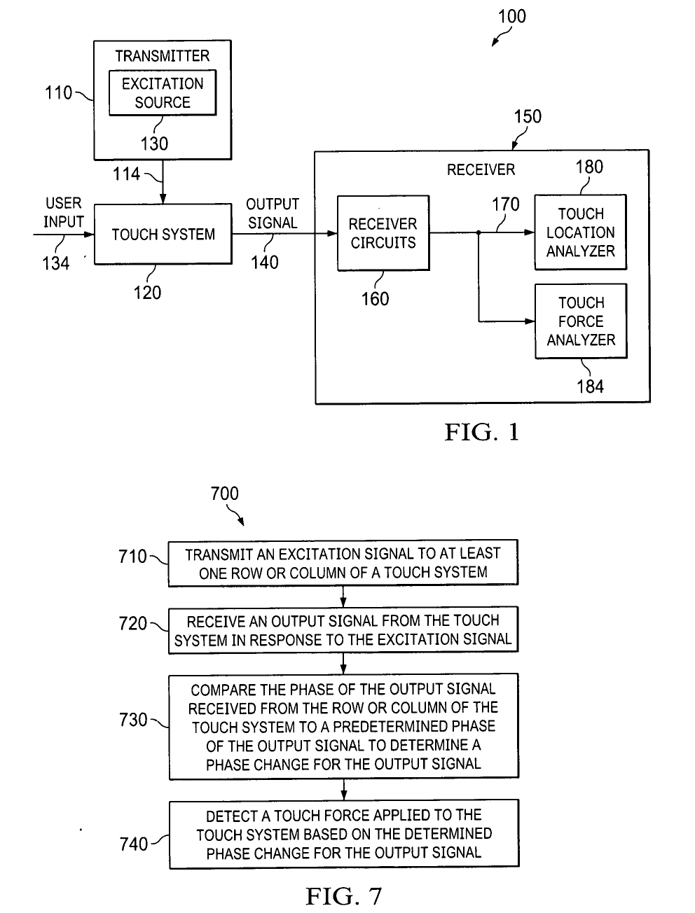

FIG. 1 is an example system 100 to determine touch location and touch force applied to a touch system. The system 100 includes a transmitter 110 to generate an excitation signal 114 to a touch system 120. An excitation source 130 (or sources see e.g., FIG. 3) provides an alternating current (AC) excitation signal 114. The touch system 100 (e.g., mutual capacitance touch system having a touch panel covering the row and columns) generates an output signal 140 in response to the excitation signal 114 and based on a user's touch to the touch system. For example, based on a user's touch at 134 to the touch system 120, corresponding to engaging one or more fingers or a stylus (or other object) with a contact surface thereof, the output signal 140 changes its amplitude and phase characteristics which can be utilized to detect where the user has touched the touch system 120 and determine an indication of the touch force that has been applied to the system. A receiver 150 receives the output signal 140 from the touch system to detect the user's touch at 134. The receiver 150 includes one or more receiver circuits 160 (depending on if single or multiple excitations sources are employed) and generates a signal 170. As used herein, the term “circuit” can include a collection of active and/or passive elements that perform a circuit function, such as an analog circuit or control circuit. Additionally or alternatively, for example, the term “circuit” can include an integrated circuit (IC) where all and/or some of the circuit elements are fabricated on a common substrate (e.g., semiconductor substrate).

The receiver signal 170 can be analyzed by a touch location analyzer 180 to determine a touch location on the touch system 120 and by a touch force analyzer 184 to determine the touch force applied to the respective location. The touch location analyzer 180 can utilize changes in received signal amplitudes and/or phase in response to the touch to determine touch location as described hereinbelow with respect to FIGS. 3 though 6. The touch force analyzer 184 can determine a touch force applied to the touch system 120 based on detecting a change in phase of the output signal 140 received from the row or column of the touch system in response to a touch that is applied to the touch system. In one example, the touch force analyzer 184 can determine the change in phase of the output signal 140 by comparing the phase of the output signal with respect to a predetermined phase of the output signal when no touch force is applied to the touch system. This can include determining one phase when no touch is applied and determining another phase when maximum touch force is applied.

The touch force analyzer 184 then determines an indication of the touch force by interpolating between the minimum and maximum phase change, where determined phases closer to the minimum phase can be associated with less touch force applied and phase changes associated with the maximum phase change can be associated with greater touch forces. A phase change detected about one-half way between the minimum and maximum phase change values can be associated with an intermediate value of maximum touch force applied. The intermediate value and interpolation can be based on linear functions, non-linear functions, or a combination of linear and non-linear functions that are related to the change in resistance of the row/column intersections based on the application of touch force to the touch panel of the touch system.

In one example, the touch force analyzer 184 multiplies the received output signal at 170 by a sine function and a cosine function to determine the real and imaginary phase components of the output signal. For example, the signal at 170 can be multiplied by the sine and cosine of 2πft where f is the frequency of the excitation signal and t is time. The touch force analyzer 184 can apply the real and imaginary phase components of the output signal to a low pass filter to generate filtered real and imaginary phase components of the output signal. This can include determining a phase angle for the output signal by computing the arctangent of the filtered real phase component divided by the imaginary filtered phase component of the output signal. In one example, a phase angle lookup table can be generated that correlates known force values applied to the touch system 120 with determined phase angles by the touch force analyzer 184 to the respective measured force. The touch force analyzer 184 determines an indication of touch force applied to the touch system by comparing the phase angle for the output signal at 170 to the determined phase angles for the output signal to the determined table phase angles, to determine the closest match to the respective force value. A calibration procedure can be conducted to generate the phase table where force instrumentation is applied to the touch system 120 and where phase angles are recorded in the lookup table as differing forces are applied by the instrumentation.

For example, the touch location analyzer 180 utilizes the amplitude and/or phase of the output signal 140 to determine one or more touch locations that touch force is applied to the touch system 120. If multiple touch locations are detected across the touch system 120, the touch force analyzer 184 can analyze touch force across the one or more touch locations with respect to a given area of a touch panel for the touch system 120, which encompasses the one or more touch locations, to quantify the touch force that is distributed across the given area of the touch system and panel. For example, forces can be averaged across two or more locations in a given area of the touch panel of the touch system to determine the force distributed across the given area. As an example, if force is detected between two rows (e.g., adjacent rows) that are known to occupy a given surface area of the touch panel in square millimeters, the force can be average across the given area to determine the distribution of force for the given area.

As noted above, the transmitter 110 can include at least one alternating current (AC) source to generate excitation signals to the touch system. In one example (see, e.g., FIG. 3), at least two of the excitation signals can be applied concurrently to at least two rows or columns of the touch system 120. The excitation signals are about 90 degrees out of phase with respect to each other when transmitted to the respective rows or columns to enable the receiver to detect touch location and force from multiple locations concurrently. As a result, the receiver 150 concurrently receives amplitude and phase information from multiple rows or columns of the touch system. The touch system 120 can be a mutual capacitance touch system having at least two rows and columns that receive the excitation signals from the transmitter 110 where the touch system generates the output signal based 140 based on the excitation signals. The output signal 140 can be analyzed with respect to phase changes for multiple row/column intersections to detect changes in phase that correlates to each row/column intersection.

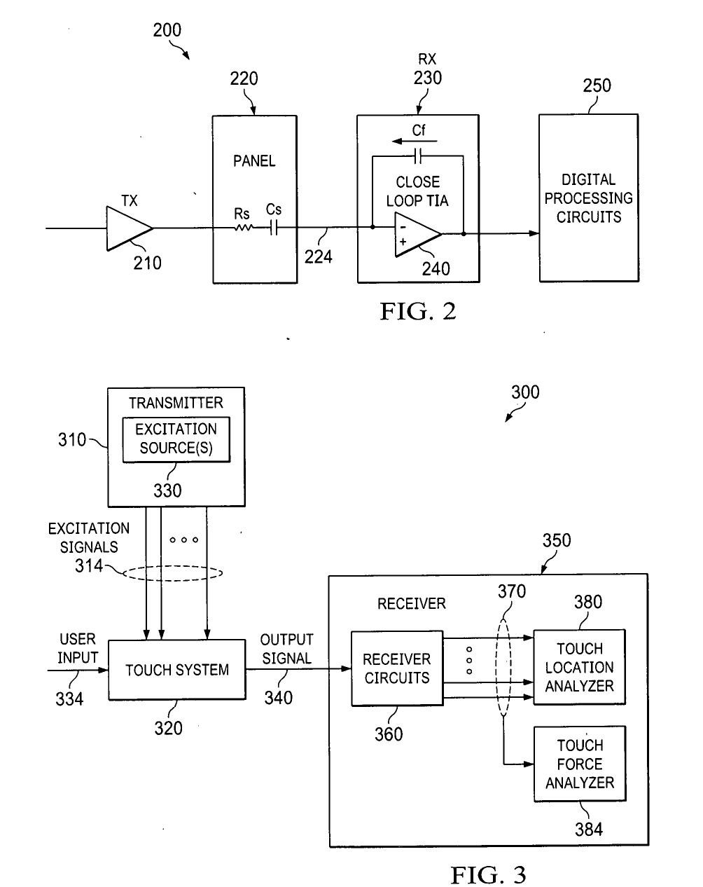

FIG. 2 is an example circuit path 200 including a row/column intersection demonstrating circuit transfer function characteristics to determine phase changes that can be used to detect touch force applied to a touch system. The circuit 200 represents a model of a transmitter 210 that excites an input row or column of a touch system 220. The touch system 220 includes a number of intersecting rows and columns each of which can be modeled as series resistance Rs and mutual capacitance Cp. When a portion of a touch screen or panel overlying an intersection is touched, the series capacitance and resistance changes, which affects the phase of an output signal 224 that is provided to a receiver 230. The receiver 230 includes a trans-impedance amplifier (TIA) 240 which includes capacitive feedback element Cf.

A digital processing circuit (e.g., digital signal processor and associated digital converters) 250 is configured to perform the phase multiplication and filtering operations described herein. The combination of Rs, Cs, and Cf define a transfer function for the system 200 wherein the transmit wave function is defined as 2πft and the circuit transfer function defined as Cs/Cf(1+j2πftRsCs)2πft. The circuit transfer function allows the touch location analyzer to determine changes in phase based on changes in impedance Rs responsive o applying force to the contact surface of the touch system. The changes in phase can be utilized to detect corresponding differences in touch force applied to the touch system. As noted previously, the touch force analyzer can multiply the received output signal by sine and cosine functions to determine the real and imaginary components of the output signal. The real and imaginary components are digitally low pass filtered. Then, an arctangent function can be computed from the quotient of the real and imaginary components to compute the phase angle of the output signal responsive to the applied force. Based on changes in the phase angle due to the change in Rs when touch force is applied, the amount of touch force applied to the touch system can be determined from the phase change.

FIG. 3 is an example system 300 to determine touch location and touch force applied to a touch system after multiple out of phase excitation signals are applied to the touch system. The system 300 includes a transmitter 310 to transmit excitation signals 314. At least one of the excitation signals 314 can be transmitted to at least one row or column of a touch system 320 and at least one other of the excitation signals can be concurrently transmitted to at least one other row or column of the touch system. In some examples, individual excitation can be provided where one row or column is excited and in a subsequent scanning sequence another row or column of the touch system 320. The transmitter 310 generates at least one of the excitation signals 314 at a given phase to one row or column of the touch system 320 and generates the other of the excitation signals at a different phase from the given phase to the other row or column of the touch system. For example, one excitation signal 314 may be generated as a sine wave and another excitation signal generated as a cosine wave thus having a 90 degree phase difference. As described herein, other phase relationships among different concurrently applied excitation signals are possible.

The transmitter 310 includes at least one alternating current (AC) source 330 to generate the excitation signals 314 to the touch system 320 where each of the excitation signals in one example are transmitted out of phase with respect to each other excitation signal. At least two of the excitation signals 314 can be generated at the same frequency or at different frequencies with respect to each other via the AC source 330. Different frequencies can be employed for the excitation signals 314 so long as they remain in their given phase relationship (e.g., orthogonal) over the integration time, which includes both the time it takes to transmit and receive signals in response to the excitation signals 314.

In one example, at least two of the excitation signals 314 can be transmitted to at least two rows or columns of the touch system 320 where the excitation signals are at least 90 degrees out of phase with respect to each other when transmitted to the respective rows or columns. In other examples, more than two excitation signals 314 can be transmitted to the touch system to further reduce scan time of the touch system. As used herein, the term “scan time” refers to the amount of time it takes to excite all of the rows or columns of the touch system 320. In single phase excitation systems, each row or column had to be excited individually to detect the presence of a touch shown as user input 334. In the multiphase system described herein, multiple rows or columns can be analyzed concurrently to reduce the scan time in half in a two phase excitation system (or reduced more if more than two excitation signals utilized).

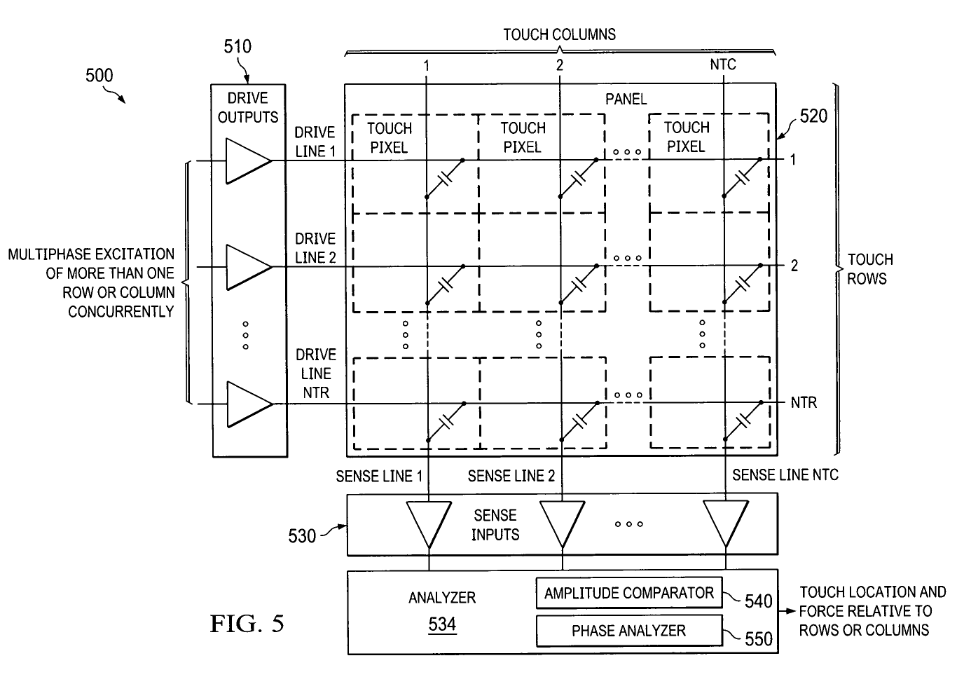

As a further example, the touch system 320 can be a mutual capacitance touch system (see e.g., FIG. 5) having at least two rows and columns that receive the excitation signals 314 from the transmitter 310 where the touch system generates an output signal 340 (or signals) based on the excitation signals. A receiver 350 receives the output signal 340 from the touch system 320. The receiver 350 includes at least two receiver circuits 360 to process the output signal 340 from the touch system 320 and generates multiple signals 370 to determine if or where a user has touched the touch system and how much force has been applied.

By providing multiphase signaling and analysis as described herein to reduce scan time of the touch system, a portion of the touch system 320 can be excited by the transmitter 310 during one scanning sequence and analyzed by the receiver 350 based on the scanning of the portion. At least one other portion of the touch system 320 can be excited by the transmitter 310 during another scanning sequence and analyzed by the receiver based on the scanning of the at least one other portion. In this manner of multiphase signaling and processing, hardware complexity can be reduced because multiple rows or columns can be scanned using fewer connection nodes to the touch system 320 to determine a touch location and touch force to the system. For example, in a two phase excitation system, half of the row or column connections from conventional systems can be reduced.

A touch location analyzer 380 compares an amplitude of the output signals received from different rows or columns of the touch system. A ratio of the output signal amplitudes from the different rows or columns of the touch system can be utilized to determine the location of the user's touch relative to the rows or columns of the touch system. For example, if the amplitude received from one row was at 20% peak and the amplitude received from another row was at 80% peak, touch location can be calculated base on the ratio of 20/80, such that 80 percent of the users touch force is affecting one row and 20% of the user's touch force is affecting the other row. As used herein, peak signal amplitude refers to the maximum signal received when no touch force is applied. If it is known that 10 millimeters separate the rows for example, the touch location is approximately is approximately 8 millimeters away from one row (the 20% peak row) and about two millimeters away from the other row (e.g., 80% peak row).

Based upon determining the touch location, a touch force analyzer 384 can then determine the touch force that has been applied at the respective location (or locations in the case where force is applied across one or more rows or columns). As described previously, the touch force analyzer 384 can determine a touch force applied to the touch system 320 based on computing a change in phase of the output signal 340 received from the row or column of the touch system after a touch is applied to the touch system. The touch force analyzer 384 can determine the change in phase of the output signal by comparing the received phase of the output signal with respect to a predetermined phase of for output signal, such as the phase of the output signal when no touch force or other known amount of force is applied to the touch system 320.

For example, the touch force analyzer 384 multiplies the output signal 340 by a sine function and a cosine function, such as disclosed herein, to determine each of the real and imaginary phase components of the output signal. The touch force analyzer 384 also applies the real and imaginary phase components of the output signal to a low pass filter to generate filtered real and imaginary phase components of the output signal. Responsive to such filtering, the touch force analyzer 384 can determine a phase angle for the output signal 340 by computing the arctangent of the filtered real phase component with respect to the imaginary filtered phase component of the output signal. In one example, a phase angle lookup table is programmed to correlate a range of measured forces applied to the touch system (between minimum and maximum expected forces) with determined respective phase angles at each force measurement. The touch force analyzer 384 determines touch force applied to the touch system by comparing the computed phase angle for the output signal (provided by touch force analyzer 384) to the determined phase angles in the table and outputs a corresponding value indicative of the applied force.

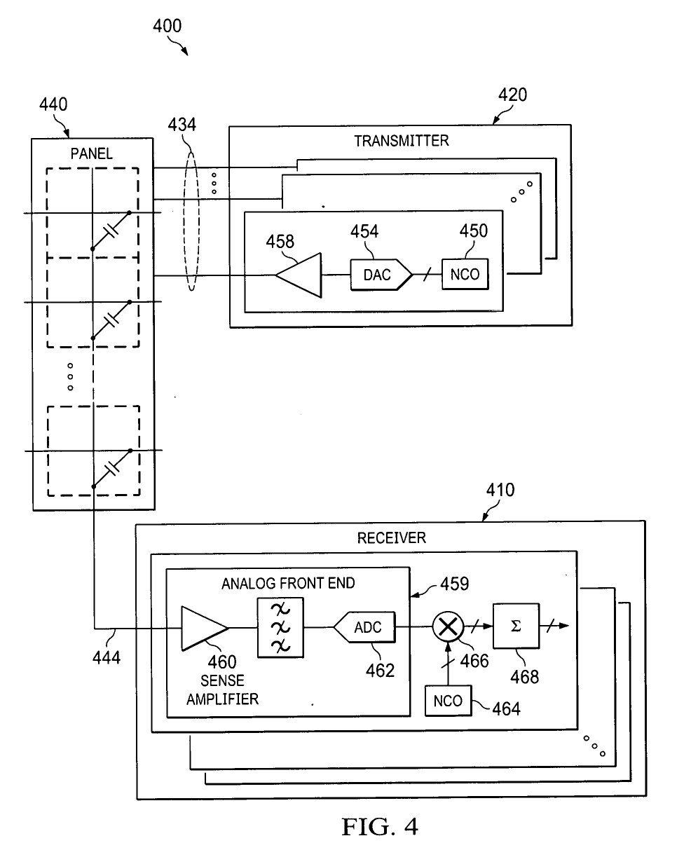

FIG. 4 illustrates an example circuit 400 of a receiver 410 and a transmitter 420 for a touch system where multiphase excitation and processing is employed to determine touch location and touch force. The transmitter 420 provides multiple out of phase excitation signals 434 to a touch panel 440. The transmitter 420 can provide row or column excitation to the touch panel 440 such as to excite more than one row or column are excited concurrently via the excitation signals 434. In this example, a capacitance touch panel 440 is illustrated. In a touch system, mutual or self capacitance can be measured by transmitting the excitation signals 434 to selected rows/columns of the panel 440. The receiver 410 receives a signal 444 in response to the excitation signals 434 applied on the columns/rows of the touch panel 440. When a touch on the panel occurs proximate to a row/column intersection, the change in signal strength and/or phase change can be detected by the receiver 410. The changes can be used to determine the touch location and associated force that is applied on the touch panel 440, as disclosed herein.

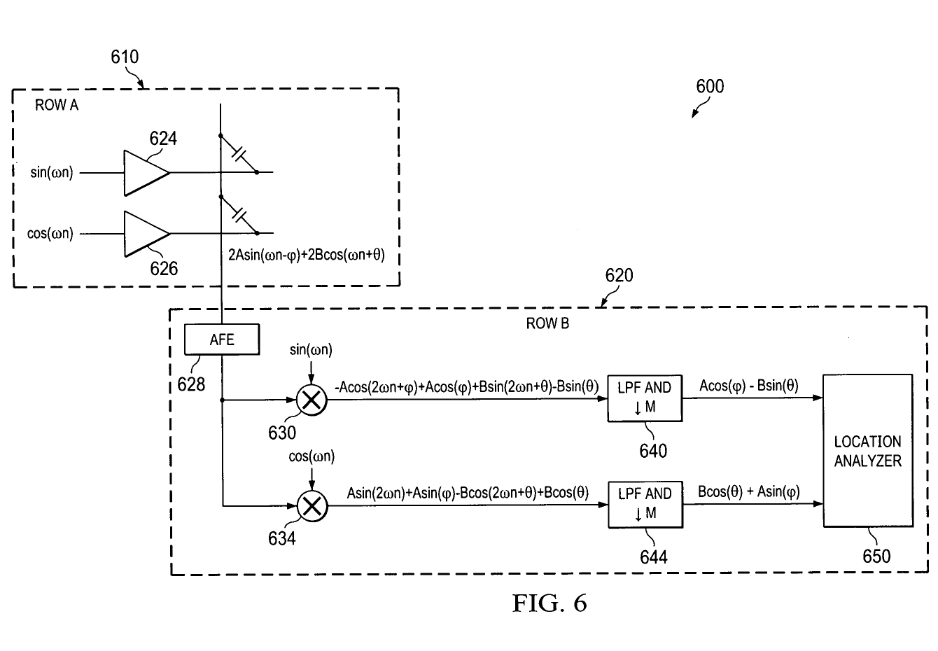

The transmitter 420 can include at least one numerically controlled oscillator (NCO) 450 which drives a digital to analog converter (DAC) 454, which in turn drives an output amplifier 458 to provide the signals 434. The receiver 410 can include an analog front end 459 that includes an input stage or amplifier 460 which drives an analog to digital converter (ADC) 462. Output from the ADC can be multiplied with a signal from an NCO 464 via a multiplier at 466 which is then summed at 468. As described herein with reference to FIG. 6, the receiver 410 can include summing junctions and filters (e.g., before or after the sense amplifier 460) to extrapolate row/column information from the signal 444 as described herein.

FIG. 5 illustrates an example of a touch system 500 that can be excited and analyzed via multiphase signaling. In the touch system 500, a known signal is transmitted via sources to respective input lines to drive a plurality of rows of a touch panel 520. Corresponding output signals are provided for each of a plurality of touch columns to a receiver via respective sense inputs 530. The change in the gain/phase of the received signal from one or more of the sense inputs 530 indicates the presence or absence of a touch and can be analyzed to determine the touch force applied to a given location on the touch panel.

To reduce the footprint of the touch controller circuit in certain examples of existing single excitation systems, one can reduce the number of receive and/or transmit channels. However, this increases the scan time. The scan time increases by the same factor as the hardware reduction. For example, if the hardware is reduced by a factor of 2, the scan time increases by a factor 2 to obtain the same performance level. However, an increase in scan time decreases the responsiveness of the touch screen controller. In the system and methods described herein, multiphase signaling is provided where two or more rows/columns of the touch panel 520 are excited concurrently effectively reducing the scan time. When the scan time is reduced, hardware complexity can likewise also be reduced.

As shown in the example of FIG. 5, an analyzer 534 (e.g., location and force analyzer) can be provided to detect a location and force for a user's touch via stylus or fingering. The analyzer 534 can include an amplitude comparator 540 to compare signal amplitudes between rows or columns to determine a signal amplitude ratio which determines touch locations at or between rows and/or columns. A phase analyzer 550 can also be provided to determine touch forces as described herein. This can include multiplying the received output signal by sine and cosine functions, applying low pass filter functions, and then determining the phase angle of the output signal. The computed phase angle can be compared with predetermined phase angle and force combinations (stored in a lookup table) to determine touch force at a given location.

FIG. 6 illustrates a circuit diagram of an example transmitter 610 and receiver circuit 620 that uses multiphase signaling and processing. In this example, a SIN signal sin(ωn) is transmitted on row 1 via source 624 and a COS signal cos(ωn) on row 2 transmitted concurrently via source 626. Both the SIN and COS can be at the same or different frequencies. When choosing different frequencies, the multiphase signals should remain orthogonal (e.g., in substantially the same phase relationship) over the integration time (transmit and receive time).

At the receiver circuit 620, the received signal represented as 2Asin(ωn+φ)+2Bcos(ωn+θ) in this example, can be received via analog front end (AFE) 628 and can be match filtered with the transmitted SIN and COS signal in the digital domain via summing junctions 630 and 634, respectively. For example, output from the summing junction 630 can be represented as −Acos(2ωn+φ)+Acos(φ)+Bsin(2ωn+θ)−Bsin(θ), and output from the other summing junction can be represented as Asin(2ωn)+Asin(φ)+Bcos(2ωn+θ)+Bcos(θ). These signals can be filtered via low pas filters 640 and 644, respectively to produce output signals Acos(φ)−Bsin(θ) and Bcos(θ)+Asin(φ), respectively. Output from the filters 650 can be analyzed for amplitude and/or phase differences by a location analyzer 650 to determine touch locations between rows or columns of the touch system.

Because the signals can be maintained in a given phase relationship with respect to each other (e.g., orthogonal), changes in the signal strength of the SIN indicates a touch on row A and the corresponding receiver while any change in COS will give the touch information on rowB and the receiver of interest. Thus, information about two touch locations can be obtained concurrently. This implies that scanning in adjacent row pairs, the touch image can be obtained in half the time. As described hereinabove, more than two adjacent rows can be concurrently scanned using signal having known out-of-phase signals, and respective output signals analyzed. One-half the number of receivers can be employed in an example to facilitate scanning the panel twice (e.g., getting half the entire panel information from the first scan and one half from the second scan). Thus, the total scan time using multiphase stimulation remains substantially the same while the hardware complexity is reduced. In some example, the receive channel can be built with a higher dynamic range to account for interference. Therefore, sending multiphase signals does not impact the individual receiver design. Thus, a factor of two in hardware improvement can be easily obtained using two excitation signals. This can also be easily extended to larger number of concurrent excitations.

In view of the structural and functional features described hereinabove, an example method is described with reference to FIG. 7. For clarity, the method is shown and described as executing serially, but parts of the method could occur in different orders and/or concurrently from that shown and described herein. Such method can be executed by various components, such as components configured in an integrated circuit, a processor or a controller.

FIG. 7 is an example method 700 to determine touch force applied to a touch system. At 710, the method 700 includes transmitting an excitation signal to at least one row or column of a touch system (e.g., via transmitter 110 of FIG. 1). At 720, the method 700 includes receiving an output signal from the touch system in response to the excitation signal, the output signal having an amplitude and phase that varies based on application of a touch to the touch system (e.g., via receiver 150 of FIG. 1). At 730, the method 700 includes comparing the phase of the output signal received from the row or column of the touch system responsive to the application of the touch to a predetermined phase of the output signal to determine a phase change for the output signal (e.g., via touch force analyzer 184 of FIG. 1). At 740, the method 700 includes determining an indication of touch force applied to the touch system based on the determined phase change (e.g., via touch force analyzer 184 of FIG. 1). Although not shown, the method 700 can include determining one or more touch locations that touch force is applied to the touch system. This can include analyzing touch force across the one or more touch locations with respect to a given area of a touch system touch screen to determine how touch force is distributed across the touch system.

In this description, the term “based on” means based at least in part on. Similarly, the term “in response to” means in at least response to. Modifications are possible in the described embodiments, and other embodiments are possible, within the scope of the claims.

1. A system, comprising:
a receiver that receives an output signal from a touch system to detect a user's touch, the output signal received in response to an excitation signal that is applied to a row or column of the touch system;
a touch location analyzer that determines a touch location in response to a touch applied to the touch system using at least one of detecting a change in phase of the output signal and a change in amplitude of the output signal; and
a touch force analyzer that determines an indication of a touch force applied to the touch system based on detecting a change in phase of the output signal received from the row or column of the touch system in response to the touch applied to the touch system.

2. The system of claim 1, wherein the touch force analyzer determines the change in phase of the output signal by comparing the phase of the output signal with respect to a predetermined phase of the output signal obtained when no touch force is applied to the touch system.

3. The system of claim 2, wherein the touch force analyzer multiplies the output signal by a sine function and a cosine function to determine real and imaginary phase components of the output signal.

4. The system of claim 3, wherein the touch force analyzer applies the real and imaginary phase components of the output signal to a low pass filter to generate filtered real and imaginary phase components of the output signal.

5. The system of claim 4, wherein the touch force analyzer determines a phase angle for the output signal by computing an arctangent of the filtered real phase component divided by the imaginary filtered phase component of the output signal.

6. The system of claim 5, further comprising a phase angle lookup table that correlates measured forces applied to the touch system with determined phase angles to a respective force value force, wherein the touch force analyzer determines the indication of touch force applied to the touch system by comparing the phase angle for the output signal to the determined phase angles, to determine the closest match to the respective force value.

7. The system of claim 5, wherein the touch location analyzer utilizes at least one of the amplitude and phase of the output signal to determine one or more touch locations where touch force is applied to the touch system, the touch force analyzer analyzes touch force across each of the one or more touch locations with respect to a given area of a touch system touch screen to determine how touch force is distributed across the touch system.

8. The system of claim 1, further comprising a transmitter that includes at least one alternating current (AC) source to generate excitation signals including the excitation signal that is applied to the row or column of the touch system.

9. The system of claim 8, wherein at least two of the excitation signals are applied to at least respective two rows or columns of the touch system, the at least two excitation signals are about 90 degrees out of phase with respect to each other when applied to the respective rows or columns to enable the receiver to receive amplitude and phase information concurrently from the at least two rows or columns of the touch system.

10. The system of claim 9, further comprising a mutual capacitance touch system having at least two rows and two columns that receive the excitation signals from the transmitter, wherein the touch system generates an output signal based on the excitation signals.

11. A system, comprising:
a receiver that receives output signals from a touch system to detect a user's touch, the output signals received in response to at least two out of phase excitation signals applied to at least two rows or columns of the touch system;
a touch location analyzer that determines a touch location in response to a touch applied to the touch system using one of detecting a change in phase of at least one of the output signals and a change in amplitude of the at least one of the output signals; and
a touch force analyzer that determines an indication of a touch force applied to the touch system at the location determined by the touch location analyzer based on detecting a change in phase in the one of the at least one of the output signals received from the respective rows or columns of the touch system in response to the touch applied to the touch system.

12. The system of claim 11, wherein the touch force analyzer determines the change in phase of the output signal by comparing the phase of the output signal with respect to a predetermined phase of the output signal when no touch force is applied to the touch system.

13. The system of claim 12, wherein the touch force analyzer multiplies the output signal by a sine function and a cosine function to determine real and imaginary phase components of the output signal.

14. The system of claim 13, wherein the touch force analyzer applies the real and imaginary phase components of the output signal to a low pass filter to generate filtered real and imaginary phase components of the output signal.

15. The system of claim 14, wherein the touch force analyzer determines a phase angle for the output signal by computing an arctangent of the filtered real phase component divided by the imaginary filtered phase component of the output signal.

16. The system of claim 15, further comprising a phase angle lookup table that correlates measured forces applied to the touch system with determined phase angles to a respective force value force, wherein the touch force analyzer determines the indication of touch force applied to the touch system by comparing the phase angle for the output signal to the determined phase angles to determine the closest match to the respective force value.

17. The system of claim 11, further comprising a transmitter to generate the at least two out of phase excitation signals including the excitation signal that is applied to the row or column, wherein the transmitter includes at least one alternating current (AC) source to generate the excitation signals to the touch system, each of the out of phase excitation signals are orthogonal with respect to each other.

18. The system of claim 17, further comprising a mutual capacitance touch system having at least two rows and columns that receive the excitation signals, wherein the touch system generates an output signal in response to the excitation signals.

19. A method, comprising:
transmitting an excitation signal to at least one row or column of a touch system;
receiving an output signal from the touch system in response to the excitation signal; the output signal having an amplitude and phase that varies based on application of a touch to the touch system;
using at least one of a change to the phase and a change to the amplitude of the output signal received from the row or column if the touch system responsive to the application of the touch to the touch system, determining a location of the touch to the touch system;
comparing the phase of the output signal received from the row or column of the touch system responsive to the application of the touch to a predetermined phase of the output signal to determine a phase change for the output signal; and
determining an indication of the touch force applied to the touch system based on the determined phase change.

20. The method of claim 19, further comprising determining one or more touch locations that touch force is applied to the touch system, and analyzing touch force across the one or more touch locations with respect to a given area of a touch system touch screen to determine how touch force is distributed across the touch system.
